(19) United States
(12) Patent Application Publication
(10) Pub. No.: US 2012/0153805 A1
(43) Pub. Date: Jun. 21, 2012

(54) ELECTRODE FOR DISCHARGE LAMP AND MANUFACTURING METHOD THEREOF

(75) Inventors: Satoru WATANABE, Tokyo (JP); Naomichi MIYAKAWA, Tokyo (JP); Yutaka KUROIWA, Tokyo (JP); Kazuhiro ITO, Tokyo (JP); Setsuro ITO, Tokyo (JP); Kei MAEDA, Tokyo (JP)

(73) Assignee: Asahi Glass Company, Limited, Tokyo (JP)

(21) Appl. No.: 13/403,325

(22) Filed: Feb. 23, 2012

Related U.S. Application Data
(63) Continuation of application No. PCT/JP10/64312, filed on Aug. 24, 2010.

(30) Foreign Application Priority Data
Aug. 25, 2009 (JP) 2009-194799

(51) Int. Cl. H01J 61/06; H01B 1/08; H01J 9/02

(52) U.S. Cl. 313/491; 445/50; 252/518.1

(57) ABSTRACT

An electrode for a discharge lamp includes an electrode body configured to emit thermal electrons. The electrode body is formed by a sintered body of a conductive mayenite compound.

### CROSS-REFERENCE TO RELATED APPLICATIONS

This application is a U.S. continuation application, filed under 35 USC 111(a) and claiming the benefit under 35 USC 120 and 365(c), of PCT application JP2010/064312 filed Aug. 24, 2010. The foregoing application is hereby incorporated herein by reference.

### FIELD

The present invention relates to a discharge lamp and, more particularly, to a thermal cathode fluorescent lamp.

### BACKGROUND

Fluorescent lamps are widely used for applications, such as an illumination, a backlight of a display device, and light irradiation in various production processes.

From among fluorescent lamps, it is common that a filament made of tungsten or molybdenum is especially used for an electrode of a hot cathode fluorescent lamp. However, in a usual case, in order to raise a starting characteristic and lamp efficiency of the fluorescent lamp, the filament is covered by an electron emission material, which is referred to as an emitter. The emitter has a function of lowering a work function of an electrode to promote thermal electron emission at the time of discharge. As such an emitter material, alkaline earth metal oxides, such as barium oxide (BaO), strontium oxide (SrO), or calcium oxide (CaO), etc., are usually used (for example, Patent Document 1).

On the other hand, recently, an example in which a single crystal conductive mayenite compound is used as an electrode for thermal field effect electron emission is reported (refer to Non-Patent Document 1: Yoshitake Toda, Sung Wng Kim, Katsuro Hayashi, Masahiro Hirano, Toshio Kamiya, Hideo Hosono, Takeshi Haraguchi and Hiroshi Yasuda, “Intense thermal field electron emission from room-temperature stable electride”, Applied Physics Letters, 87, 254103 (2005))

However, in a fluorescent lamp using an electrode having an emitter made of alkaline earth metal oxide such as Patent Document 1, it has been pointed out that there is a problem of an emitter being consumed with duration of use. It is considered that this is because (1) an alkaline earth metal oxide usually has a high vapor pressure at a high temperature, and (2) adhesiveness between an alkaline earth metal oxide and a filament is not good. That is, an emitter may be consumed for a relatively short period of time because an emitter heated at a high-temperature may be evaporated during usage due to an influence of (1), and the emitter may be omitted from a filament due to an influence of (2).

If such a consumption of an emitter occurs, there may be a problem in that a light-emitting efficiency (more specifically, a thermal electron emission efficiency) is decreased. Additionally, if consumption of an emitter becomes severe, a part of a filament may be exposed, and, thereby, a burnout of an electrode may occur easily. As a result, there may be a problem that a service life of the fluorescent lamp is shortened.

Additionally, the single crystal conductive mayenite disclosed in the above-mentioned Non-Patent Document 1 is not one which is based on an assumption of usage as an electrode of a fluorescent lamp. Accordingly, when such an electrode is used for a fluorescent lamp, it is not clear whether or not an appropriate thermal electron emission property is obtained. Further, there is a problem in that manufacturing is extremely complex in an electrode using a single crystal material.

### SUMMARY

It is a general object of the present invention to provide an electrode for a fluorescent lamp, which can eliminate the above-mentioned problems.

A more specific object of the present invention is to provide an electrode for a fluorescent lamp, which is usable properly for a long time, and a fluorescent lamp equipped with such an electrode, and also to provide a manufacturing method of such an electrode.

In order to achieve the above-mentioned object, there is provided according to one aspect of the present invention an electrode for a discharge lamp, including: an electrode body comprising a sintered body comprising a conductive mayenite compound, wherein the electrode body part is configured to emit thermal electrons.

There is provided according to another aspect of the present invention a discharge lamp, including: a bulb having an inner space in which mercury and a rare gas are filled; a phosphor provided on an inner surface of the bulb; and an electrode that causes a discharge to be generated and maintained in the internal space, wherein the electrode is the above-mentioned electrode.

In the above-mentioned electrode and the above-mentioned discharge lamp, the electrode body may include a cluster structure having a neck part that is formed by particles being joined with each other, and a surface of the cluster structure has a three-dimensional concavo-convex structure comprised of the particles protruding partially. The electrode body may further include an oxide of alkaline earth metal. The oxide of alkaline earth metal may include at least one kind of oxide selected from a group consisting of barium oxide (BaO), strontium oxide (SrO) and calcium oxide (CaO).

There is provided according to another aspect of the present invention a manufacturing method of an electrode for a discharge lamp comprising an electrode body that causes thermal electrons to be emitted, the manufacturing method including: (1a) a step of preparing a powder containing a mayenite compound; (1b) a step of forming a shaped material from said powder; (1c) a step of obtaining a sintered body by firing said shaped material; and (1d) a step of providing a conductivity to said sintered body.

In the above-mentioned manufacturing method, the step (1d) of providing a conductivity may include a step of heat-treating the sintered body within a reducing atmosphere.

There is provided according to a further aspect of the present invention a manufacturing method of an electrode for a discharge lamp comprising an electrode body that causes thermal electrons to be emitted, the manufacturing method comprising: (2a) a step of preparing a powder containing a mayenite compound; (2b) a step of forming a shaped material from the powder; and (2c) a step of obtaining a sintered body having an electrical conductivity by firing the shaped material.

In the above-mentioned manufacturing method, the step (2c) of obtaining a sintered body may include a step of heat-treating the shaped material within a reducing atmosphere.

According to the present invention, it becomes possible to provide an electrode for a discharge lamp which is usable properly for a long period of time, and a discharge lamp equipped with such an electrode. Additionally, it becomes possible to provide a manufacturing method of such an electrode.

Other objects, features and advantages of the present invention will become more apparent from the following detailed description when read in conjunction with the accompanying drawings.

### BRIEF DESCRIPTION OF THE DRAWINGS

FIG. 1 is an enlarged view of a partially cut-away cross-sectional view illustrating an outline example of a fluorescent lamp according to the present invention.

FIG. 2 is a schematic view illustrating an example of a structure of an electrode according to the present invention.

FIG. 3 is a schematic view illustrating an example of a structure of a conventional electrode.

FIG. 4 is a photograph illustrating an example of a surface form of a conductive mayenite compound sintered body used for an electrode according to the present invention.

FIG. 5(a)-(c) are outline views schematically illustrating an example of a forming process of a neck part of a conductive mayenite compound sintered body.

FIG. 6 is a flowchart illustrating an example of a method for manufacturing an electrode body of the electrode according to the present invention.

FIG. 7 is a flowchart illustrating another example of a method for manufacturing an electrode body of the electrode according to the present invention.

FIG. 8 is a SEM photograph illustrating a surface form of an electrode according to a practical example 2.

FIG. 9 is a SEM photograph illustrating a surface form of an electrode according to a comparative example 2.

FIG. 10 is graph indicating a relationship between an applied voltage and a thermal electron emission current of an electrode according to a practical example 3.

FIG. 11 is a graph illustrating a Richardson plot of the electrode according to the practical example 3.

FIG. 12 is a SEM photograph illustrating a surface form of the electrode according to the comparative example after an arc discharge test.

FIG. 13 is a graph indicating a relationship between Ar energy and a sputtering rate when Ar is incident on BaO or a mayenite compound.

### DETAILED DESCRIPTION OF THE PREFERRED EMBODIMENTS

A description will be given below of modes of the present invention according to the drawings.

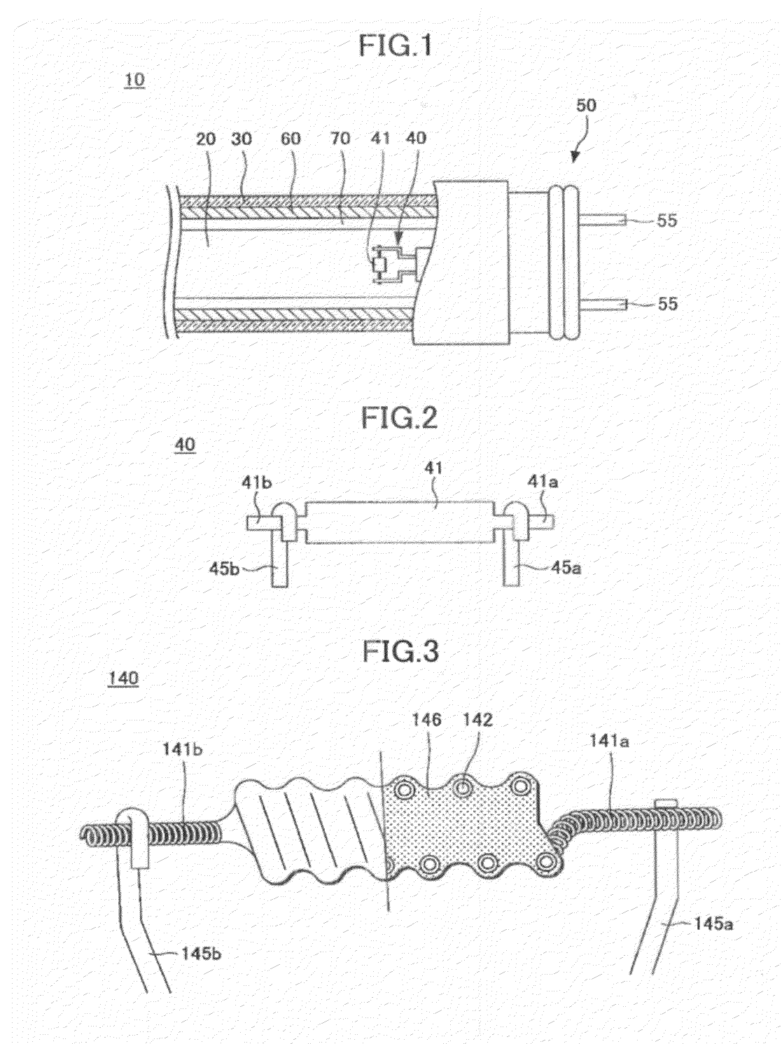

FIG. 1 is an enlarged view of a partially cut-away cross-sectional view illustrating a straight tube fluorescent lamp as an example of a fluorescent lamp, which is one form of a discharge lamp preferably applied in the present invention. Additionally, FIG. 2 schematically illustrates an example of an electrode included in the fluorescent lamp illustrated in FIG. 1. Although a left-side part of the fluorescent lamp is not illustrated in FIG. 1, it is clear for a person skilled in the art that this part has a structure that is symmetrical with the right-side part illustrated.

As illustrated in FIG. 1, the fluorescent lamp 10 includes a tubular bulb 30, which is formed of glass and has a discharge space 20, an electrode 40, and a plug 50.

A protection film 60 and a phosphor 70 are provided on an inner surface of the bulb 30. Discharge gas is enclosed in the discharge space 20, the discharge gas containing a rare gas, and, for example, argon gas containing mercury is used for the discharge gas. The protection film 60 prevents dissolution of sodium contained in the bulb 30, and plays a roll of preventing the inner wall of the fluorescent lamp from being blackened by suppressing production of a compound of mainly mercury and sodium.

The plug 50 is provided on both ends of the fluorescent lamp 10 to support the bulb 30, and has pin parts 55.

The electrodes 40 are sealed at both ends of the bulb 30.

As illustrated in FIG. 2, the electrode 40 includes an electrode body 41 having two end parts 41a and 41b and support lines 45a and 45b electrically connected to the end parts 41a and 41b, respectively. The support lines 45a and 45b have conductivity, and the other ends thereof are electrically connected to pin parts 55 of a plug 50, respectively. Additionally, the support lines 45a and 45b play a roll of supporting the electrode body 41.

It should be noted that the structure of the electrode 40 is a mere example, and it is clear for a person skilled in the art that the electrode 40 can have other structures. For example, although the electrode body 41 of the electrode 40 has a prismatic shape in FIG. 2, the shape of the electrode body 41 is not limited to this, and may have, for example, a linear structure. The linear structure includes a structure such as a coil. A cross-sectional shape in a direction perpendicular to a longitudinal direction of the linear structure may be, for example, a circular shape, an oval shape or a rectangular shape.

Additionally, although the end parts 41a and 41b of the electrode body 41 are smaller in their cross sections than the central part of the electrode body 41 in FIG. 2, the end parts 41a and 41b of the electrode body 41 may have a cross-sectional dimensions substantially equal to the central part of the electrode body 41.

Further, in the electrode 40 illustrated in FIG. 2, the electrode body 41 and the support lines 45a and 45b are formed as separate elements. However, the electrode body 41 and the support lines 45a and 45b may be integrated into one piece.

In the fluorescent lamp 10, when a voltage is applied across the both electrodes 40 (only one is illustrated in FIG. 1), the electrode (cathode side) 40 is heated, and electrons (thermal electrons) are emitted from the electrode body 41 heated to a high temperature. The emitted electrons move to the other electrode (anode side) 40, and, thereby, a discharge is started. Subsequently, when electrons flowing by the discharge collide with mercury atoms encapsulated in the discharge space 20 of the bulb 30, the mercury atoms are excited and ultraviolet lights are emitted when the excited mercury returns to the ground state. When the thus-emitted ultraviolet lights are irradiated to the phosphor 70 of the bulb 30, visible lights are generated from the phosphor 70. According to the above-mentioned series of phenomena, visible lights are caused to be radiated from the fluorescent lamp 10.

A description will be given of a feature of the present invention.

A description is given first, with reference to FIG. 3, of a structure of a conventional electrode and a problem thereof. FIG. 3 is a schematic view illustrating an example of a structure of a conventional electrode.

The conventional electrode 140 includes a filament 142 having two end parts 141a and 141b and support lines 145a and 145b electrically joined to the end parts 141a and 141b, respectively. Similar to the above-mentioned case of FIG. 2, the support lines 145a and 145b have electrical conductivity, and the other ends are electrically connected to pin parts of a plug of a fluorescent lamp, respectively. Additionally, the support lines 145a and 145b play a roll of supporting the filament 142.

In a normal case, the filament 142 is formed by a coil made of a metal such as tungsten (W), molybdenum (Mo), etc. Additionally, the filament is covered by an electron emission material referred to as an emitter 146. As for the material of the emitter 146, alkaline earth metal oxides, such as barium oxide (BaO), strontium oxide (SrO), or a calcium oxide (CaO), are used. This is because an alkaline earth metal oxide usually has a low work function, and can promote thermal electron emission by application of a small voltage.

However, there is a problem pointed out conventionally in the electrode 140 constituted as in FIG. 3 that the emitter 146 formed of an alkaline earth metal oxide material is easily worn with passage of use time.

It is considered that this is because (1) an alkaline earth metal oxide usually has a high vapor pressure at a high temperature, and (2) adhesiveness between an alkaline earth metal oxide and a filament is not good.

For example, barium oxide (BaO) has a melting point and a boiling point of about 1923° C. and about 2000° C., respectively, and calcium oxide (CaO) has a melting point and a boiling point of about 2572° C. and about 2850° C., respectively, and thus, the melting point and the boiling point of each of the materials are close to each other. Thus, it is assumed from those physicality values that the alkaline earth metal oxides have a relatively high vapor pressure at a high temperature.

In a fluorescent lamp having only a conventional material as the emitter 146, it is considered that the emitter 146 may be consumed for a relatively short period of time because the emitter 146 heated at a high-temperature may be evaporated during usage due to an influence of (1), and the emitter 146 may be omitted from the filament 142 due to an influence of (2).

It should be noted that if such a consumption of an emitter occurs, there may be a problem in that a light-emitting efficiency (more specifically, a thermal electron emission efficiency) is decreased. Additionally, if consumption of the emitter 146 becomes severe, the filament 142 may be exposed, and, thereby, a burnout of an electrode may occur easily. As a result, there may be a problem that a service life of the fluorescent lamp is shortened.

On the other hand, in the fluorescent lamp 10 according to the present embodiment, the electrode 40 does not have a structure in which the filament 142 is covered by the emitter 146. That is, in the fluorescent lamp 10 according to the present embodiment, the electrode body 41 of the electrode 40 is formed by a sintered body of a conductive mayenite compound.

As mentioned later, the conductive mayenite compound is relatively stable in a high-temperature region exceeding 1100° C., and there is little problem that the conductive mayenite compound is evaporated during usage of the fluorescent lamp as in the alkaline earth metal oxides. Additionally, because a metal filament such as in the conventional one is not needed in the present invention, the electrode body 41 has a structure which does not have an interface between a metal filament and an emitter, at which adhesiveness is concerned.

Therefore, forming the electrode 40 by a sintered body of a mayenite compound reduces a problem in that an emitter at a high-temperature is evaporated or dropped off during usage of a fluorescent lamp. Additionally, because the electrode according to the present embodiment does not have a filament such as a conventional one, there is no possibility of breaking wire due to exposure of filament after wear of an emitter. Thus, according to the present embodiment, a fluorescent lamp can be used properly for a long period of time.

In addition, recently, an example in which a single crystal conductive mayenite compound is used as an electrode for thermal field emission is reported (Non-Patent Document 1) has been reported. However, this document is not one that assumes usage of an electrode of a fluorescent lamp. Accordingly, it is unclear whether or not an appropriate thermal electron emission property can be obtained when an electrode formed of a single crystal conductine mayenite compound is used for a fluorescent lamp. Actually, as mentioned later, it is reported that a work function is relatively large in the electrode formed of a single crystal conductive mayenite compound. Additionally, there is a problem in that a manufacturing process is extremely complex in an electrode using a single crystal material.

On the other hand, according to the present embodiment, the electrode body 41 of the electrode 40 is constituted by a sintered body (polycrystal) of a conductive mayenite compound.

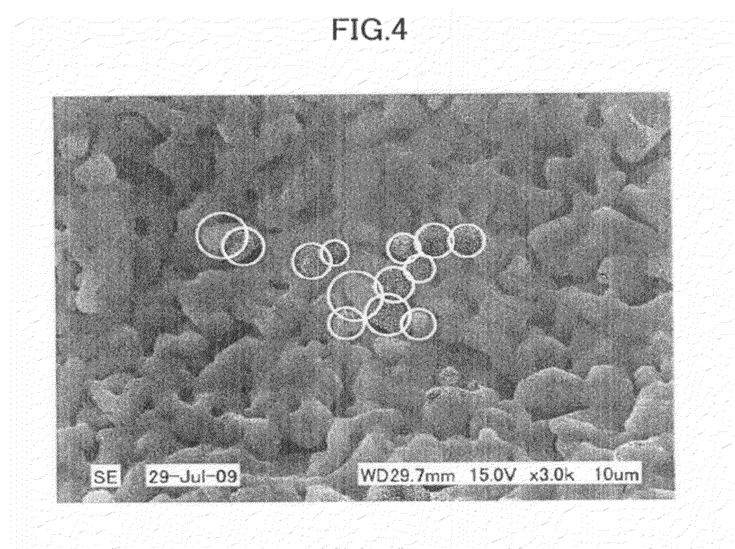

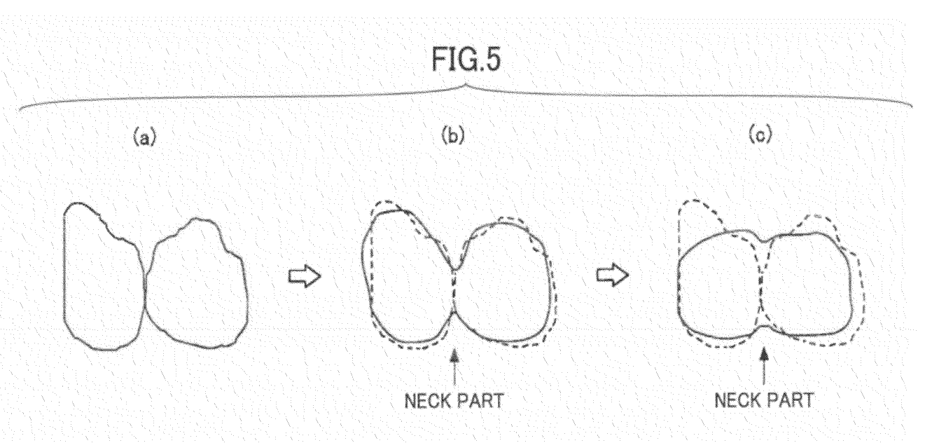

A surface form when observing the electrode body 41, which is constituted by a sintered body of a conductive mayenite compound formed by using a powder of a mayenite compound, by a scanning electron microscope (SEM) is illustrated in FIG. 4 (3000 times).

As interpreted from the figure, the sintered body of the conductive mayenite compound has a cluster structure having many neck parts, which are formed by particles being combined with each other, and the surface thereof exhibits a three-dimensional concavo-convex structure formed by particles being partially protruded. Here, the “particles” do not always designate a powder of a mayenite compound before being sintered but also means a particulate part in the form when observing the sintered body.

A description is given, with reference to FIG. 5, of a forming process of such a characteristic surface form. FIG. 5 is an outline view schematically illustrating an example of a forming process of a neck part of a sintered body of a conductive mayenite compound.

First, when two particles arranged as illustrated in FIG. 5(a) are subjected to a sintering process, bonding such as illustrated by a solid line in FIG. 5(b) is produced. Additionally, the bonding of particles progresses further, a structure illustrated by a solid line in FIG. 5(c) is obtained. In FIG. 5(b) and (c), a portion in which the particles are combined with each other corresponds to the neck part. It should be noted that the dashed lines in FIG. 5(b) and (c) illustrate, for comparison, particle shapes before the sintering process (that is, FIG. 5(a)).

When such an interparticle bond progresses between the particles, a cluster-like structure as a whole is formed. On the surface of the cluster structure (especially, a discharge space side), a three-dimensional concavo-convex structure in which particles are partially protruded, is obtained.

Because bonding of the neck parts with each other progresses in the form of FIG. 5(c), it can be a form in which, apparently, particles are distributed inside a dense part having a relatively flat and smooth surface and the particles are partially protruded from the surface.

The structure of the sintered body as illustrated in FIG. 4 is formed in a process of firing particles, and it is inferable that it is a complex phenomena caused by re-deposition of other crystals formed by a mayenite compound or a structural elements of the mayenite compound on the sintered body surface and the sintering of a powder of a mayenite compound being occurred simultaneously.

Moreover, when the sintered body having the surface structure such as illustrated in FIG. 4 is used as a material for electrode, the surface area thereof increases dramatically and it becomes possible to emit a larger number of thermal electrons, and, thereby, it becomes possible to obtain a larger electric current easily. Therefore, an extremely excellent thermal electron property can be obtained as compared to an electrode constituted by a usual single crystal conductive mayenite compound.

Therefore, the sintered body of the conductive mayenite compound according to the present embodiment can be used effectively for an electrode of a fluorescent lamp or the like. Additionally, according to the present embodiment, an effect can be obtained such that a manufacturing method of an electrode is extremely simplified.

It should be noted that in the surface foam illustrated in FIG. 4, a size of the protruding part indicated by, for example, “◯” (hereinafter, referred to as “domain diameter”) is about 0.1 μm to 10 μm. If the domain diameter is smaller than 0.1 μm, or the domain diameter is larger than 10 μm, an effect of increasing the surface area may not be obtained sufficiently.

(Details of Each Member of the Fluorescent Lamp of the Present Invention)

Next, a description is given in detail of the electrode 40 and the phosphor 70 of the fluorescent lamp according to the present embodiment. It should be noted that the specifications of the bulb 30, the plug 50 and the protection film 60 are obvious for a person skilled in the art, and descriptions thereof will be omitted.

(Electrode 40)

As mentioned above, the electrode body 41 of the electrode 40 according to the present embodiment is formed of a sintered body of a conductive mayenite compound.

Here, the “mayenite compound” is a general designation of 12CaO.7Al₂O₃ (hereinafter, may also be referred to as “C12A7”) and a compound having a crystal structure equivalent to the C12A7 (isomorphic compound).

Generally, a mayenite compound contains oxygen ions in a cage, and, particularly, the oxygen ions are referred to as “free oxygen ions”.

Additionally, a part or all of the “free oxygen ions” are replaceable by electrons according to a reducing process or the like, and, particularly, one having an electron density of 1.0×10¹⁵ cm⁻³ or more is referred to as “conductive mayenite compound”. Because the “conductive mayenite compound” has a conductivity as indicated by the designation thereof, it can be used as an electrode material according to the present embodiment.

In the present embodiment, the electron density of the “conductive mayenite compound” is preferably 1.0×10¹⁸ cm⁻³ or more, and, more preferably, 1.0×10¹⁹ cm⁻³ or more, and, further preferably, 1.0×10²⁰ cm⁻³ or more. If the electron density of the conductive mayenite compound is lower than 1.0×10¹⁸ cm⁻³, it is possible that when it is used as an electrode, the resistance of the electrode is large.

It should be noted that, in the present embodiment, the electron density of the conductive mayenite compound means a measured value which is calculated according to measurement by an electron spin resonance apparatus, or a measured value of a spin density calculated by measurement of an absorption coefficient. Generally, it is preferable to perform the measurement using an electron spin resonance apparatus (ESR apparatus) if the measured value of spin density is lower than 10¹⁹ cm⁻³, and if it exceeds 10¹⁸ cm⁻³, it is preferable to calculate the electron density as mentioned below. First, a measurement is carried out of an intensity of light absorption by electrons inside a cage of the conductive mayenite compound to acquire the absorption coefficient at 2.8 eV. Subsequently, a quantitative determination of the electron density of the conductive mayenite compound is carried out using that the obtained absorption coefficient is in proportion to the electron density. Moreover, if the conductive mayenite compound is powder and it is difficult to carry out the measurement of a transmission spectrum by a photometer, a diffuse reflectance spectrum is measured using an integrating sphere so that the electron density of the conductive mayenite compound is calculated from the value acquired according to the Kubelka-Munk method.

In the present embodiment, as long as the mayenite compound has a crystal structure equivalent to the C12A7 crystal structure, which includes calcium (Ca), aluminum (Al) and oxygen (O), a part or all of atoms of at least one kind that is selected from calcium (Ca), aluminum (Al) and oxygen (O) may be replaced by other atoms or atomic groups. For example, a part of calcium (Ca) may be replaced by atoms, such as magnesium (Mg), strontium (Sr), barium (Ba), lithium (Li), sodium (Na), chromium (Cr), manganese (Mn), cerium (Ce), cobalt (Co), nickel (Ni), and/or copper (Cu). Moreover, a part of aluminum (Al) may be replaced by silicon (Si), germanium (Ge), boron (B), gallium (Ga), titanium (Ti), manganese (Mn), iron (Fe), cerium (Ce), praseodymium (Pr), scandium (Sc), lantern (La), yttrium (Y), europium (Eu), yttrbium (Yb), cobalt (Co), nickel (Ni), terbium (Tb), etc. Moreover, oxygen of a cage frame may be replaced by nitrogen (N), etc.

The conductive mayenite compound is preferably a 12CaO.7Al₂O₃ compound, a 12SrO.7Al₂O₃ compound, a mixed crystal compound of those, or an isomorphic compound of those.

Although it is not limited to those in the present embodiment, compounds (1) to (4) mentioned below are taken into consideration as a mayenite compound.

(1) Calcium magnesium aluminate (Ca_{1-y}Mg_{y})₁₂Al₁₄O₃₃ or calcium strontium aluminate (Ca_{1-z}Sr_{z})₁₂Al₁₄O₃₃ in which a part of calcium (Ca) which forms a frame of C12A7 is replaced by magnesium (Mg) or strontium (Sr). It should be noted that y and z are preferably 0.1 or less.

(2) Ca₁₂Al₁₀Si₄O₃₅ which is a silicon substitution type mayenite.

(3) For example, Ca₁₂Al₁₄O₃₂:2OH⁻ or Ca₁₂Al₁₄O₃₂:2F⁻ in which free oxygen ions in a cage are replaced by cations, such as H⁻, H₂⁻, H²⁻, O⁻, O₂⁻, F⁻, Cl⁻, Br⁻, S²⁻, or Au⁻.

(4) For example, Wadalite Ca₁₂Al₁₀Si₄O₃₂:6Cl⁻ in which both anions and cations are replaced.

In addition, in the present embodiment, although the electrode body 41 may be constituted solely by conductive mayenite compound, it may contain a different additive material. As for a different additive material, for example, there are oxides of alkaline earth metals. As the oxides of alkaline earth metals, barium oxide (BaO), strontium oxide (SrO) or calcium oxide (CaO) is preferable. If the electrode body 41 contains a conductive mayenite compound and such an oxide simultaneously, an excellent thermal electron emission property can be obtained over a wide temperature range from a low-temperature range (˜about 800° C.) to a high-temperature range (˜about 1300° C.).

The different additive material is added by a range of, for example, 1 wt %˜50 wt %, to the total weight of the electrode body 41.

It should be noted that the resistance value of the electrode body 41 may be a range of 0.1Ω˜100Ω. The resistance value of the electrode body 41 is preferably in a range of 0.5˜50Ω, more preferably in a range of 1˜20Ω, and further preferably in a range of 2˜10Ω. If the resistance value is smaller than 0.1Ω, an electric current flowing through the entire circuit becomes large and it may become difficult to selectively heat only the electrode. Additionally, if it is larger than 100Ω, an electric current hardly flows, and it may become difficult to heat the electrode sufficiently.

In the present embodiment, the conductivity of the conductive mayenite compound can be adjusted relatively easily according to a heat treatment under a reducing atmosphere mentioned later. Accordingly, the resistance value of the electrode body 41 can be controlled relatively easily. Additionally, the resistance value can be controlled according to denseness of the sintered body.

(Phosphor 70)

As a phosphor 70, for example, an europium activated yttrium oxide phosphor, a cerium terbium activated lanthanum phosphate phosphor, an europium activated strontium halophosphate phosphor, an europium activated barium magnesium aluminate phosphor, an europium manganese activated barium magnesium aluminate phosphor, a terbium activated cerium aluminate phosphor, a terbium activated cerium magnesium aluminate phosphor, and an antimony activated calcium halophosphate phosphor may be used solely or in mixture.

It should be noted that with respect to the fluorescent lamp 10, a configuration, a size, a watt number and a color and color rendering property of the light emitted by the fluorescent lamp are not limited specifically. With respect to a configuration, it is not limited to a straight tube as illustrated in FIG. 1, and, for example, may be a shape such as a circular shape, a bicyclic shape, a twin shape, a compact shape, a U-shape, a light bulb shape, etc. With respect to a size, for example, it may be of a 4-type˜a 110-type. With respect to a watt number, for example, it may be several watts to several hundreds watts. With respect to a light color, for example, there are a daylight color, a day white color, a white color, a warm white color, an electric bulb color, etc.

(Manufacturing Method of Electrode Body)

Next, a description is given of a manufacturing method of the electrode body 41 of the electrode according to the present embodiment.

The manufacturing method of the electrode body 41 is generally separated into two methods according to a difference in a process of providing a conductivity to a mayenite compound. The first method is a method of providing a conductivity to a mayenite compound after obtaining a sintered body by sintering a powder of the mayenite compound and processing the sintered body into a desired shape. On the other hand, the second method is a method of providing a conductivity simultaneously when sintering a powder of a mayenite compound to obtain a sintered body.

(First Method)

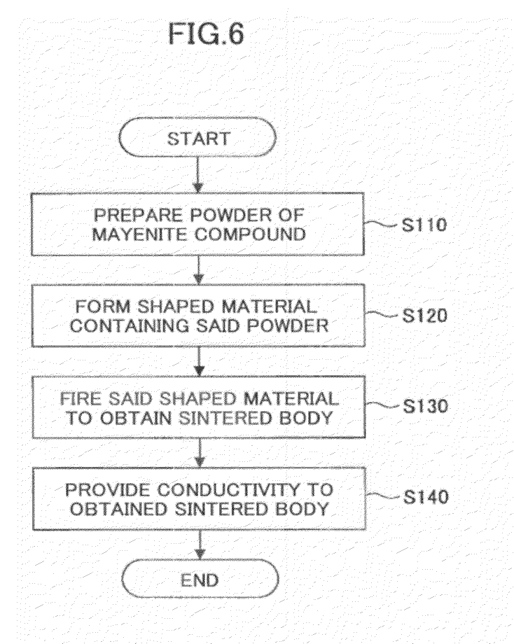

FIG. 6 illustrates a flowchart of the first method.

As illustrated in FIG. 6, the first method includes a step of preparing a powder containing a mayenite compound (step 110: S110); a step of forming a shaped material containing said powder (step 120: S120); a step of obtaining a sintered body by firing said shaped material (step 130: S130); and a step of providing a conductivity to the obtained sintered body (step 140: S140). A description is given below of each step.

(Step 110)

First, a mayenite compound powder having an average particle diameter of about 1 μm to 10 μm is prepared. Especially, the average particle diameter of the powder is preferably 2 μm or more and 6 μm or less. It should be noted that if the average particle diameter is smaller than 1 μm, the powder is condensed and it becomes difficult to make the powder finer, and if it is 10 μm or larger, it may become difficult to progress the sintering.

In a usual case, the mayenite compound powder is prepared by coarse-powdering a mayenite compound raw material and further grinding the coarse powder to a fine powder. A stamp mill, an automatic mortar, etc., may be used for the coarse-powdering of the raw material, and the material is crushed until an average particle diameter becomes about 20 μm. In order to crush the coarse powder until the fine powder having the above-mentioned average particle diameter, a ball mill, a bead mill, etc., may be used.

(Step 120)

Next, a shaped material containing a mayenite compound powder is produced.

The manufacturing method of the shaped material is not limited to a special one, and the shaped material may be produced through a paste (or a slurry, the same below) or through pressure faulting of a powder or a paste.

For example, the paste may be prepared by adding the above-mentioned prepared powder to a solvent together with a binder and agitating them. As a binder, either an organic binder or an inorganic binder may be used. As an organic binder, for example, nitro cellulose, ethyl cellulose, polyethylene oxide, methyl cellulose, hydroxyl propyl methyl cellulose, carboxy methyl cellulose, hydroxy ethyl cellulose, polyvinyl alcohol, polyacrylic acid soda, polyacrylic amide, polyvinyl butyral, polyethylene, polypropylene, polystyrene, ethylene-acetic acid vinyl copolymer, acrylic resin, polyamide resin, etc., may be used. Moreover, as an inorganic binder, for example, a silicate soda base, a metal alkoxide base, etc., may be used. Moreover, as a solvent, butyl acetate, terpineol, alcohol expressed by a chemical-formula CₙH₂ₙ₊₁OH (n=1˜4) may be used.

In the case of methyl cellulose, for example, a blending amount of the binder is preferably 0.5 to 60 volume % with respect to the above-mentioned prepared powder. Depending on the forming method, a plasticizing agent, a dispersing agent or a lubricating agent may by added. The plasticizing agent can provided plasticity when shaping. The dispersing agent improves dispersion by destroying aggregate of the powder. The lubricating agent can make the shaping easy by reducing friction between powders and improving fluidity. As the plasticizing agent, for example, glycerin, polyethylene glycol, dibutyl terephthalate, etc., may be used. As the dispersing agent, for example, fatty acid, ester phosphate, synthetic surface-active agent, benzenesulfonic acid, etc., may be used. As the lubricating agent, for example, polyethylene glycol ethyl ether, polyoxyethylene ester, etc., may be used.

Thereafter, the paste is subjected to extrusion forming or injection forming to obtain the shaped material.

Alternatively, the above-mentioned prepared powder or paste may be put in a mold, and pressurizing the mold to form a shaped material of a desired shape.

(Step 130)

Next, the obtained shaped material is fired. It should be noted that if the shaped material contains a solvent, the shaped material may be held in a temperature range of 50° C. to 200° C. for 20 to 30 minutes to cause the solvent to be evaporated and removed beforehand. Additionally, if the shaped material contains a binder, the shaped material may be held in a temperature range of 200° C. to 800° C. for 20 to 30 minutes to remove the binder beforehand. Alternatively, both processes may be performed simultaneously.

The condition of firing is not limited in particular.

The firing process is performed, for example, in an atmospheric ambient, a vacuum, or an inert gas ambient.

The firing temperature is in a range of 1200° C. to 1415° C., and is preferably in a range of 1250° C. to 1350° C. At a temperature lower than 1200° C., firing may be insufficient and the obtained sintered body may become brittle. Additionally, if the sintering temperature is higher than 1415° C., melting of the powder progresses and the shape of the shaped material may not be maintained.

Although the time period for holding at the above-mentioned temperature may be adjusted so that the firing of the shaped material is completed, the time period is preferably 5 minutes or longer, more preferably, 10 minutes or longer, and further preferably 15 minutes or longer. If the holding time is shorter than 5 minutes, the sintering may not progress sufficiently. Additionally, although there is no problem in particular if the holding time is increased, considering a manufacturing cost, the holding time is preferably within 6 hours.

Thereafter, the obtained sintered body is processed to be in a desired shape. The processing method is not limited in particular, and machining, electro-discharge machining, laser machining, etc., may be applied.

(Step 140)

Next, a process of providing conductivity to the obtained sintered body (mayenite compound) is performed.

Providing conductivity to the sintered body can be performed by heat-treating the sintered body in a reducing atmosphere. Here, the reducing atmosphere means an atmosphere or a depressurized environment in which a reducing agent exists in a portion contacting the atmosphere and an oxygen partial pressure is 10⁻³ Pa or lower. As a reducing agent, for example, powder of carbon or aluminum may be mixed into the mayenite compound, or carbon, calcium, aluminum or titanium may be provided to a portion contacting the atmosphere. In a case of carbon, there is, for example, a method of firing the shaped material, which is put in a carbon container, under a vacuum.

The oxygen partial pressure is, for example, equal to or lower than 10⁻⁵ Pa, and preferably equal to or lower than 10⁻¹⁰ Pa, and, more preferably, equal to or lower than 10⁻¹⁵ Pa. If the oxygen partial pressure is higher than 10⁻³ Pa, a sufficient conductivity may not be obtained.

The heat treatment temperature is preferably in a range of 600° C. to 1415° C. The heat treatment temperature is preferably 1000° C. to 1400° C., and, more preferably, 1200° C. to 1370° C., and, further preferably, 1300° C. to 1350° C. If the heat treatment temperature is lower than 600° C., it is possible that a sufficient conductivity cannot be provided to the mayenite compound. Moreover, if the heat treatment temperature is higher than 1415° C., melting of the mayenite compound progresses and there is a possibility that a shape of the shaped material cannot be maintained.

The heat treatment time (holding time) is preferably in a range of 5 minutes to 6 hours, more preferably, 10 minutes to 4 hours, and, further preferably, 15 minutes to 2 hours. If the holding time is less than 5 minutes, it is possible that a sufficient conductivity cannot be obtained. Moreover, if the holding time is increased, there is no problem in the properties in particular but preferably it is within 6 hours in consideration of the manufacturing cost.

According to the above-mentioned process, the electrode body formed of a conductive mayenite compound can be fabricated.

(Second Method)

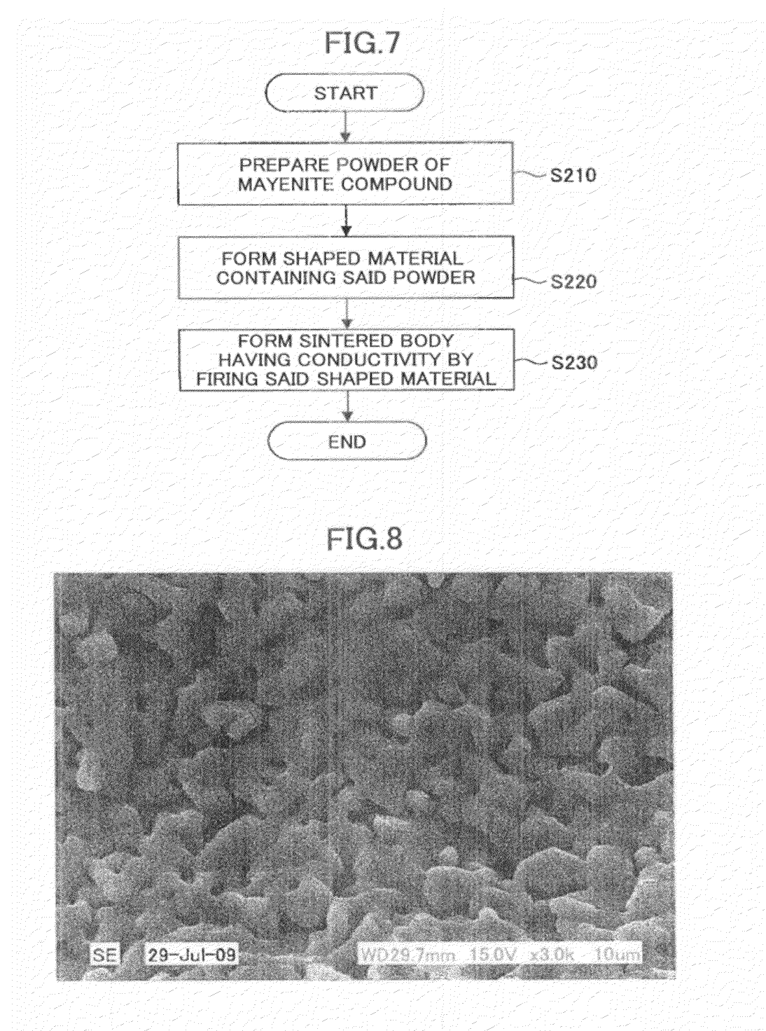

FIG. 7 illustrates a flowchart of the second method.

As illustrated in FIG. 7, the second method includes a step of preparing a powder containing a mayenite compound (step 210: S210); a step of forming a shaped material containing said powder (step 220: S220); and a step of obtaining a sintered body by firing said shaped material and simultaneously providing a conductivity to the sintered body (step 230: S230). Among those, step 210 and step 220 are the same as step 110 and step 120 of the above-mentioned first method. Thus, a description is given below of step 230 in detail.

(Step 230)

In this step, the shaped material obtained in step 220 is sintered by a firing process. It should be noted that if the shaped material contains a solvent, the shaped material may be held in a temperature range of 50° C. to 200° C. for 20 to 30 minutes to cause the solvent to be evaporated and removed beforehand. Additionally, if the shaped material contains a binder, the shaped material may be held in a temperature range of 200° C. to 800° C. for 20 to 30 minutes to remove the binder beforehand. Alternatively, both processes may be performed simultaneously.

The firing process can be performed by heat-treating the shaped material in a reducing atmosphere. The reducing atmosphere means an atmosphere or a depressurized environment in which a reducing agent exists in a portion contacting the atmosphere and an oxygen partial pressure is 10⁻³ Pa or lower. As a reducing agent, for example, powder of carbon or aluminum may be mixed into the mayenite compound, or carbon, calcium, aluminum or titanium may be provided to a portion contacting the atmosphere. In a case of carbon, there is, for example, a method of firing the shaped material, which is put in a carbon container, under a vacuum.

The oxygen partial pressure is, for example, equal to or lower than 10⁻⁵ Pa, and preferably 10⁻¹⁰ Pa, and, more preferably, equal to or lower than 10⁻¹⁵ Pa. If the oxygen partial pressure is equal to or higher than 10⁻³ Pa, a sufficient conductivity may not be obtained.

The firing temperature is in a range of 1200° C. to 1415° C., and is preferably in a range of 1250° C. to 1350° C. At a temperature lower than 1200° C., it is possible that sintering hardly progresses and the obtained sintered body may become brittle. Additionally, it is possible that a sufficient conductivity cannot be provided to the mayenite compound. On the other hand, if the firing temperature is higher than 1415° C., melting of the powder progresses and the shape of the shaped material may not be maintained.

The firing time (holding time) can be any time period if the sintering of the shaped material is completed and a sufficient conductivity can be provided. The holding time is preferably in a range of 5 minutes to 6 hours, more preferably, in a range of 10 minutes to 4 hours, and, further preferably, in a range of 15 minutes to 2 hours. If the holding time is less than 5 minutes, it is possible that a sufficient conductivity cannot be obtained. Moreover, if the holding time is increased, there is no problem in the properties in particular but preferably it is within 6 hours in consideration of the manufacturing cost.

According to the above-mentioned process, the electrode body formed of a conductive mayenite compound can be fabricated.

In the above-mentioned manufacturing method, the manufacturing method of the present invention has been explained with an example of the case where the electrode body is constituted by only a conductive mayenite compound.

On the other hand, in a case of forming the electrode body containing a mixture of a mayenite compound and an alkaline earth metal oxide, a mixture powder may be prepared by, for example, adding a desired alkaline earth metal carbonate to a mayenite compound powder in the above-mentioned steps 110 and 210. However, if such a mixture powder is used as a start material, a treatment of removing CO₂ generated in a process of reaction is needed. This is because, if CO₂ remains, mercury in the fluorescent lamp is deteriorated and a light-emitting efficiency is decreased.

Removal of CO₂ may be performed by, for example, holding the shaped material at a temperature of 800° C. to 1200° C. for about 20 to about 30 minutes under a nitrogen atmosphere or a vacuum beforehand.

By the way, when forming an emitter by alkaline earth metal oxides, such as barium oxide (BaO) as conventional, the following manufacturing method has been used.

(i) A slurry containing a carbonate powder of an alkaline earth metal (for example, BaCO₃) is applied to a filament.

(ii) An electric current is supplied to the filament within a bulb of a fluorescent lamp to heat the filament. Thereby the carbonate powder decomposes into an oxide, and an emitter made of an alkaline earth metal oxide is formed on the filament.

However, according to such a method, there is a problem in that an appropriate oxide emitter cannot be obtained if the decomposition of the carbonate is insufficient. Moreover, according to this method, carbon dioxide (CO₂) is generated in a heating process, and if the carbon dioxide (CO₂) remains in the fluorescent lamp, there is a higher possibility of giving a bad influence to the performance of the fluorescent lamp due to a possible chemical change of mercury.

On the other hand, according to the present embodiment, if the emitter is formed of only a mayenite compound, there is no generation of carbon dioxide (CO₂) because a carbonate of alkaline-earth metals is not contained as a start material at the time of forming the emitter, and, thus, a subordinate effect that a possibility that a bad influence is given to the performance of the fluorescent lamp is suppressed is acquired.

Moreover, according to the present embodiment, there is provided a fluorescent lamp including: a bulb having an internal space in which mercury and a rare gas are filled; a phosphor provided on an inner surface of the bulb; and an electrode configured to generate and maintain a discharge in the above-mentioned internal space, wherein an electrode body is made of a sintered body of a mayenite compound.

Specifically, the fluorescent lamp illustrated in FIG. 1 is provided. The fluorescent lamp has the bulb 30 having an inner surface to which the protective film 60 and the phosphor 70 are applied, and mercury (Hg) gas for exciting phosphor and argon (Ar) as a rare gas are filled in the inner space of the bulb. Furthermore, the electrode 40 for generating and maintaining a discharge is provided in the above-mentioned internal space. The electrode 40 is formed of a sintered body of a mayenite compound. In such a fluorescent lamp, wearing of the electrode when discharging is suppressed and a stable characteristic can be maintained for a long period of time.

### PRACTICAL EXAMPLE

Next, a description is given of practical examples of the present invention.

### Practical Example 1

An electrode sample constituted by a sintered body of a conductive mayenite compound was formed according a method mentioned below.

(Synthesis of the Mayenite Compound)

After mixing the powders of calcium carbonate (CaCO₃) and aluminum oxide (Al₂O₃) so that a molar ratio is 12:7, the mixture powder was maintained in an atmosphere at 1300° C. for 6 hours. Then, the obtained sintered body was crushed by an automatic mortar to obtain a powder (hereinafter, referred to as a powder A1). A particle size of the powder A1 was measured by a laser diffraction scattering method (SALD-2100, manufactured by Shimazu Corporation). An average particle size was 20 μm. Additionally, it was continued by an X-ray analysis that the powder A1 had solely 12CaO.7Al₂O₃ and the powder A1 was a (non-conductive) mayenite compound. Further, an electron density of the powder A1 was acquired by performing measurements by an ESR apparatus, and the electron density was less than 1×10¹⁵ cm⁻³.

Then, the powder A1 was pressure-formed by a pressure of 2 MPa to produce a shaped material of a disc-shape having a diameter of 1 cm and a thickness of 5 mm. Further, the shaped material was heated at 1350° C. to obtain a sintered body. The obtained sintered body was put in a carbon container with a lid, and the carbon container was put in an electric furnace in which a vacuum was formed with an oxygen partial pressure equal to or lower than 10⁻³ Pa, and is maintained at 1300° C. for 2 hours. Further, the obtained sample was crushed using a dry ball mill and a powder A2 was obtained. As a result of measurement according to the above-mentioned laser diffraction scattering method, the average particle diameter of the powder A2 was 5 μm.

A diffuse reflectance spectrum was measured with respect to the powder A2, and an electron density of the powder A2 was acquired according to the Kubelka-Munk method. As a result, the electron density of the powder A2 was 7×10¹⁸ cm⁻³, and it was confirmed that the powder A2 was a conductive mayenite compound.

(Preparation of Electrode)

Next, the powder A2 was pressure-formed and a shaped material of a disc-shape having a diameter of 1 cm and a thickness of 5 mm was produced. The shaped material was put in a carbon container with a lid, and a vacuum of 10⁻³ Pa or lower was formed inside the container, and maintained at 1300° C. for 2 hours. Thereby, a sintered body B was obtained.

A quadratic prism form sample was produced by grinding the sintered body B. The dimensions of the quadratic prism form sample were about 2 mm in length×about 2 mm in width×about 10 mm in height. After processing, a heat treatment was applied to the quadratic prism form sample. The heat treatment was performed by heating the quadratic prism form sample at 1325° C. for 2 hours under a vacuum environment having an oxygen partial pressure equal to or lower than 10⁻³ Pa in a state where the quadratic prism form sample was put in a carbon container.

According to the above-mentioned process, an electrode sample (electrode according to the practical example 1) was obtained.

With respect to the thus-obtained electrode according to the practical example 1, a diffuse reflectance spectrum was measured, and an electron density was acquired by the Kubelka-Munk method. As a result, the electron density was 3×10²⁰ cm⁻³. Additionally, it was confirmed by an X-ray diffraction that the electrode according to practical example 1 has only the 12Cao.7Al₂O₃ structure, and was a mayenite compound. Moreover, the weight of the conductive mayenite compound forming the electrode body was 109 mg.

Further, platinum was vapor-deposited on both ends (an area from an end surface to 1 mm) of the electrode according to practical example 1. Measuring terminals were connected to the platinum vapor-deposited parts and a resistance of the electrode according to practical example 1 was measured, and the resistance value was 4Ω.

### Practical Example 2

The above-mentioned powder A1 was further crushed by a wet ball mill using isopropyl alcohol as a solvent. The crushed powder was suctioned and filtered, and dried in air of 80° C. to obtain a powder A3. An average particle diameter of the powder A3 was 5 μm.

With respect to the powder A3, an electron density thereof was acquired by measurements by an ESR apparatus. As a result, the electron density of the powder A3 was smaller than 1×10¹⁵ cm⁻³, and the powder A3 was a non-conductive mayenite compound.

Then, the powder A3 and polyvinyl alcohol as a binder were mixed with a weight ratio of 99:1, and the mixture thereof was injected into a mold. A pressure of 2 MPa was applied to the mold, and a shaped material of a quadratic prism form was obtained. The dimensions of the shaped material was about 2 mm in length×about 2 mm in width×about 10 mm in height. The binder contained in the shaped material was removed by maintaining the shaped material at 300° C. for 30 minutes under an atmospheric ambient.

Thereafter, the shaped material was put in a carbon container with a lid, and the container was arranged inside an electric furnace. A vacuum was framed in the electric furnace and the shaped material was heat-treated under a reducing atmosphere such that an oxygen partial pressure in the furnace was equal to or lower than 10⁻³ Pa. The heat treatment temperature was 1325° C. and the holding time was 2 hours. Thereby, an electrode formed of a mayenite compound was obtained. It should be noted that the dimensions of the electrode were about 1.9 mm in length×about 1.9 mm in width×about 9.7 mm in height.

According to the process mentioned above, an electrode sample (electrode according to practical example 2) was obtained.

With respect to the thus-obtained electrode according to the practical example 2, a diffuse reflectance spectrum was measured, and an electron density was acquired by the Kubelka-Munk method. As a result, the electron density was 3×10²⁰ cm⁻³. Additionally, it was confirmed by an X-ray diffraction that the electrode according to practical example 2 has only the 12Cao.7Al₂O₃ structure, and was a mayenite compound. Moreover, the weight of the conductive mayenite compound forming the electrode body was 94 mg.

Further, platinum was vapor-deposited on both ends (an area from an end surface to 1 mm) of the electrode according to practical example 2. Measuring terminals were connected to the platinum vapor-deposited parts and a resistance of the electrode according to practical example 2 was measured, and the resistance value was 5Ω.

### Comparative Example 1

A so-called tungsten filament of a double coil structure (W-460100 manufactured by the Nilaco Corporation) was used as an electrode sample (electrode according to comparative example 1) without change.

### Comparative Example 2

A powder of barium carbonate (manufactured by Kanto Chemical Co., Inc.) was applied to the coil part of the above-mentioned tungsten filament, and an electric current was supplied to the filament in a vacuum of which oxygen partial pressure is equal to or lower than 10⁻³ Pa. The voltage was 8 V, the temperature of the filament was about 1000° C., and the time of supplying an electric current was 15 minutes.

Thereby, an electrode having a filament on which an emitter is deposited was obtained (hereinafter, referred to as “electrode according to comparative example 2”). As a result of an X-ray diffraction, it was found that, in the electrode according to comparative example 2, the emitter was formed of only barium oxide (BaO). The weight of the deposited emitter was 17 mg.

(Surface Form of Each Electrode)

The surface of each electrode (except for the electrode according to comparative example 1) obtained according to the method mentioned above was observed using the FE-SEM apparatus (S-4300 manufactured by Hitachi Ltd.).

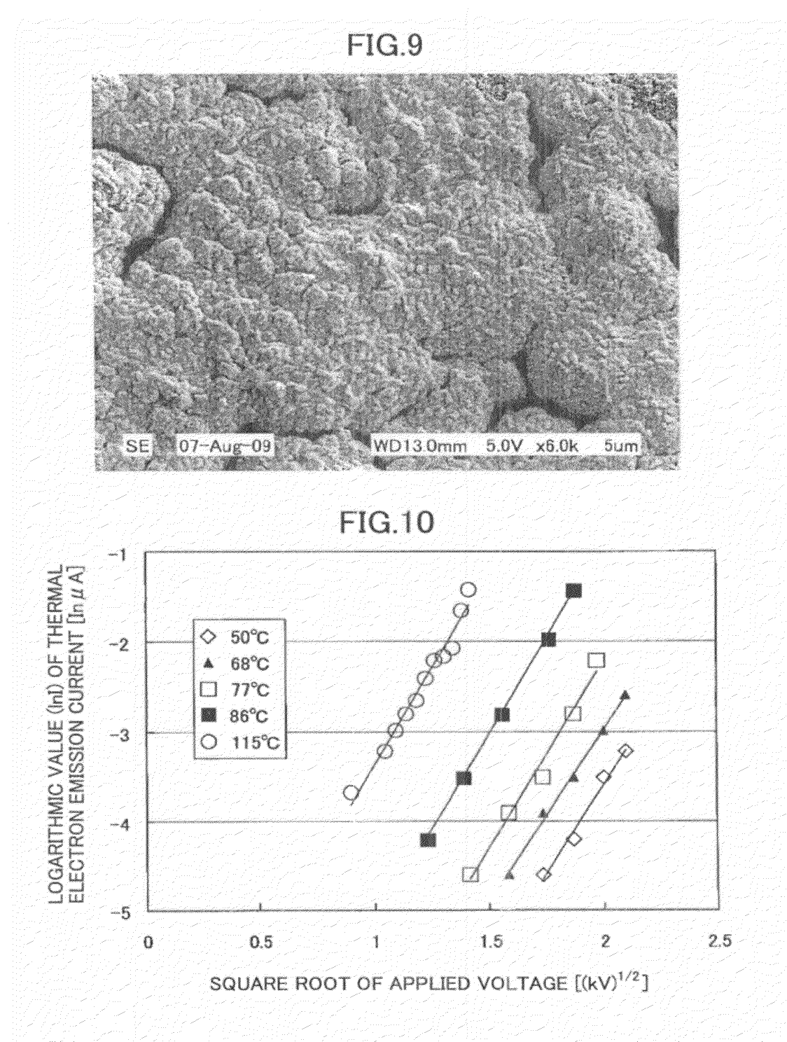

FIG. 8 and FIG. 9 illustrate surface forms of the electrode according to practical example 2 (observed in 3000 times magnification) and the electrode according to comparative example 2 (observed in 6000 times magnification), respectively.

As illustrated in FIG. 8, in the electrode according to practical example 2, an end of a cluster having many neck parts formed by particles coupled with each other expresses a three-dimensional structure configured to protrude intricately. The surface form of the electrode according to practical example 1 was almost the same as the case of practical example 2. On the other hand, as illustrated in FIG. 9, the electrode according to comparative example 2 had a structure such that flat and relatively smooth island parts are partially segmentized by large grooves.

(Evaluation of Thermal Electron Emission Property)

The thermal electron emission property of each electrode was evaluated according to the following method.

First, one of the above-mentioned electrodes (hereinafter, referred to as “sample electrode”) and a collector electrode are placed in a vacuum chamber so that the collector electrode is placed at a distance of 7 cm from the sample electrode, and air in the vacuum chamber was evacuated to form a vacuum of about 10⁻⁴ Pa.

Then, an electric current was supplied to the sample electrode in a state where a voltage of 1 kV is applied across the both electrodes. Then, thermal electrons emitted by the sample electrode (actually, an electric current value flowing in the collector electrode) when the sample electrode was heated to a predetermined temperature were measured.

The temperature of the sample electrodes was set to 900° C., 1000° C., 1100° C., 1200° C., and 1300° C. The temperature of the sample electrode was measured by a radiation thermometer (TR-630 manufactured by Minolta Co., Ltd.)

Results obtained for each electrode are collectively indicated in Table 1.

TABLE 1

| | electrode | electrode temperature | | | | |
|---|---|---|---|---|---|---|
| sample | material | 900° C. | 1000° C. | 1100° C. | 1200° C. | 1300° C. |
| Practical | Conductive | ◯ | ◯ | ◯ | ◯ | ◯ |
| Example 1 | Mayenite | | | | | |
| Practical | Conductive | ◯ | ◯ | ◯ | ◯ | ◯ |
| Example 2 | Mayenite | | | | | |
| Comparative | Tungsten | X | X | X | X | ◯ |
| Example 1 | | | | | | |
| Comparative | Tungsten + | ◯ | ◯ | ◯ | — | — |
| Example 2 | BaO | | | | | |

In Table 1, indication of ◯ represents that an electric current due to thermal electron emission exceeded 10 μA in experiments. X represents that an electric current due to thermal electron emission was equal to or smaller than 10 μA.—represents that a measurement was not achieved because the emitter provided to the filament evaporated rapidly and stable thermal electron emission did not occur.

It can be appreciated from the results that, in the cases of electrodes according to the practical examples 1 and 2, a good thermal electron emission property can be obtained at any temperature from 900° C. to 1300° C. On the other hand, in the case of the electrode according to comparative example 1, a good thermal electron emission property was not obtained in a temperature range of 900° C. to 1200° C. Moreover, in the electrode according to comparative example 2, when the filament temperature was at 1200° C. or higher, the emitter was evaporated during measurement and a stable thermal electron emission was not obtained and it was not able to measure an electric current due to thermal electron emission accurately.

It was found from those results that the electrodes according to practical examples 1 and 2 have good thermal electron emission properties in a wide temperature range of 900° C. to 1300° C.

(Evaluation of Work Function)

A work function of an electrode sample (hereinafter, referred to as “electrode according to practical example 3”) formed of a sintered body of a conductive mayenite compound.

(Fabrication of Electrode Sample)

The electrode according to practical example 3 was produced according to the following method.

First, the above-mentioned powder A1 was pressure-formed with a pressure of 2 MPa and a shaped material of a disc-shape having a diameter of 1 cm and a thickness of 1 mm was produced. The shaped material was put in a carbon container with a lid, and the container was heated in an electric furnace inside of which is set to a depressurized atmosphere of 10⁻³ Pa or lower to obtain a sintered body. The heat treatment temperature was 1350° C. and the holding time was 2 hours.

As a result of X-ray diffraction, it was confirmed that the obtained sintered body has the 12CaO.7Al₂O₃ structure and is a polycrystalline body because crystal orientations are not eccentrically-located in a specific direction. Moreover, a diffuse reflectance spectrum of the obtained sintered body was measured, and an electron density of the sintered body was acquired by the Kubelka-Munk method. As a result, the electron density was 3×10²⁰ cm⁻³. It should be noted that a single crystal body of a mayenite compound is produced by the Czochralski method or the floating-zone method, and the single crystal body cannot be obtained according to the fabrication method of the present application.

Subsequently, the sintered body was roughly crushed by a agate mortal, and a sample of about 1 mm square size was obtained. Platinum is vapor-deposited on one side of the sample, and the sample was bonded to a copper plate (30 mm square, 3 mm thickness) via an electrically conductive adhesive (Dotito XA-819A manufactured by Fujikura Kasei Co., Ltd.) so that the platinum vapor-deposited surface serves as a bonding surface. Thereafter, the copper plate was maintained at 200° C. for 2 hours under atmosphere to cure the adhesive. Thereby, the electrode according to practical example 3 was obtained.

(Test Method)

Using the electrode according to practical example 3, both electrodes were arranged in a vacuum chamber so that an interval between an extreme end part of the sintered body of the mayenite compound and a usual copper plate electrode (30 mm square, 3 mm thickness) is set to 0.1 mm. Both electrodes were arranged so that the copper plates are in parallel. Next, the interior of the vacuum chamber was evacuated to about 10⁻⁴ Pa. The surface of the electrode according to practical example 3 was heated by a carbon heater to adjust the electrode to test temperatures. The test temperatures were 50° C., 68° C., 77° C., 86° C. and 115° C.

In this state, a voltage was applied between the electrode according to practical example 3 and the usual copper electrode, and a thermal electron emission current generated from the electrode according to practical example 3 was measured.

(Measurement Result)

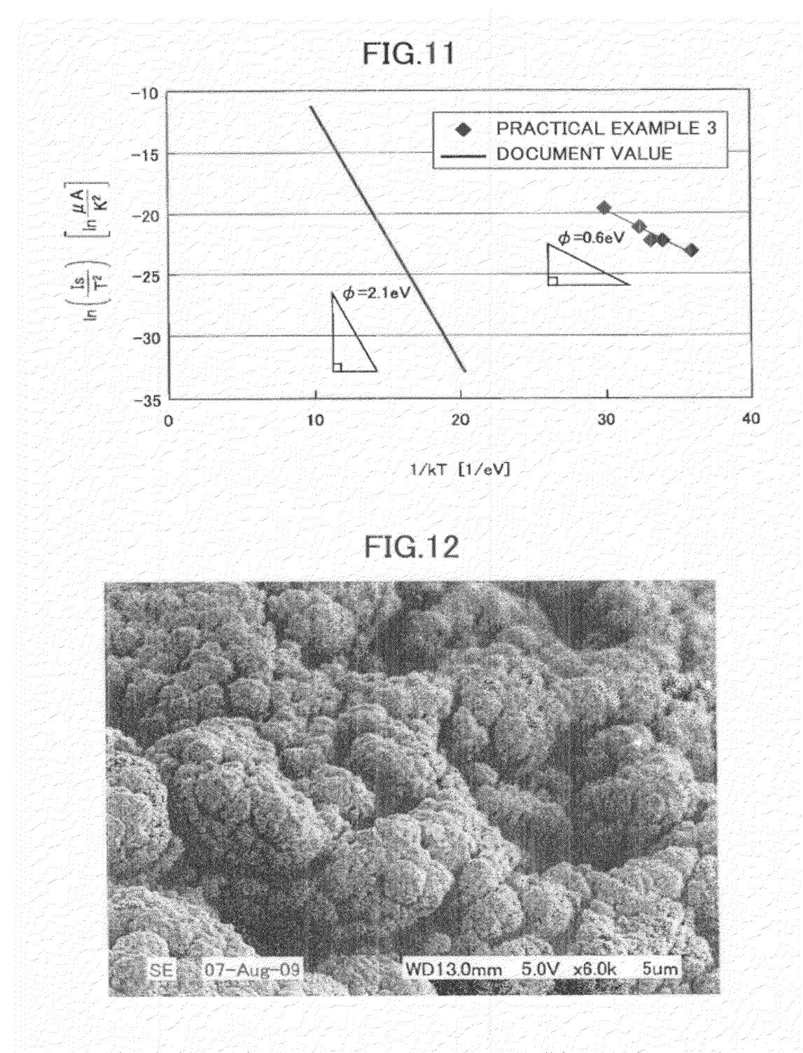

FIG. 10 illustrates results obtained at each temperature of 50° C. to 115° C. In FIG. 10, the horizontal axis is expressed by square root of applied voltage (kV), and the vertical axis is expressed by natural logarithm (ln) of thermal electron emission current (μA).

From the obtained results, a saturation emission current Is, when the applied voltage becomes 0, was acquired according to extrapolation. Additionally, using the saturation emission current Is, a work function φ of the electrode according to practical example 3 was calculated according to the Richardson plot method. It should be noted that, according to the Richardson plot method, a work function φ of an electrode is calculated from an inclination of a line obtained when an index ln(Is/T2), which is obtained from the above-mentioned saturation emission current Is and a measured temperature T, is plotted with respect to an inverse number (1/kT) of a product of the temperature and the Boltzmann constant k (the foundation of vacuum nanoelectronics, written by Yoshihiko Yamamoto, Japan Society for the Promotion of Science, P80-81).

FIG. 11 illustrates the results of the Richardson plot. From the inclination of the plot line, the work function of the electrode according to practical example 3 was calculated to be about 0.6 eV. It should be noted that a result of a case where a single crystal conductive mayenite compound is used as an electrode, which are recited in the above-mentioned Non-Patent Document 1, is indicated in the figure. In this case, it was reported that the work function of the electrode is about 2.1 eV, and it was found that, in the electrode according to practical example 3, the work function is significantly reduced as compared to the electrode made of a single crystal conductive mayenite.

(Arc Discharge Test)

An arc discharge test was carried out for each of the sample electrodes according to practical example 1, practical example 2, comparative example 1, and comparative example 2 by the following method.

First, one of the above-mentioned sample electrodes was placed in a vacuum chamber as a cathode, and a tungsten electrode was also placed in the vacuum chamber as an anode at a position separated from the sample electrode by a distance of 5 mm, and, then, air inside the vacuum chamber was evacuated to form a vacuum of about 10⁻⁴ Pa. Then, Ar gas was introduced into the vacuum chamber to set the inside pressure to 338 Pa. Further, a voltage of 100 V was applied across the sample electrode (cathode) and the tungsten electrode (anode).

Subsequently, while the voltage was applied across the electrodes, an electric current is supplied to the sample electrode to generate an arc discharge. When generating an arc discharge, an amount of electric current supplied to the sample electrode was adjusted so that an arc discharge current becomes 0.2 A, and a temperature of the sample electrode at that time was measured by the above-mentioned radiation thermometer.

After the discharge was caused to continue for 1 hour, the experiment was ended and a change in the emitter was observed visually. Moreover, the surface of the sample electrode after the test was observed using a FE-SEM apparatus. Further, a weight of each sample electrode was measured before and after the test, and a weight reduction amount of each sample electrode was evaluated.

The results obtained by the experiments are indicated collectively in Table 2.

TABLE 2

| | | | Result of | Weight |
|---|---|---|---|---|
| | Emitter | Electrode | Visual | Reduction |
| Sample | Material | Temp. | Check | Amount |
| Practical | Conductive | 1000° C. | No Change | 1 mg |
| Example 1 | Mayenite | | | |
| Practical | Conductive | 1000° C. | No Change | N.D |
| Example 2 | Mayenite | | | |
| Comparative | Tungsten | 1400° C. | No Change | Not |
| Example 1 | | | | Measured |
| Comparative | Tungsten + | 800° C. | Drop off | 5 mg |
| Example 2 | BaO | | | |

As indicated in Table 2, as a result of visual observation, there was no large change in the emitters (electrodes) in the electrodes according to the practical example 1, practical example 2, and comparative example 1. On the other hand, in the electrode according to the comparative example 2, it was observed that the emitter was partially dropped off. Additionally, it was observed that many black attached materials, which are considered to be scattered from the BaO emitter, had adhered on a periphery of the electrode after the test. Moreover, it was found from the measurement results of the weight reduction amount that a weight reduction was hardly recognized in the electrodes according to practical examples 1 and practical example 2, whereas the weight of the electrode according to comparative example 2 was reduced.

FIG. 12 illustrates a surface form of the electrode according to comparative example 2 after the test. From comparison between FIG. 12 and FIG. 9, it can be appreciated that the surface form of the electrode according to comparative example 2 has been changed due to the ark discharge test, that is, the grooves illustrated in FIG. 12 are deeper than the grooves of FIG. 9 and the island parts are separated into smaller areas.

### Practical Example 4

### Simulation Calculation of Sputter Resistance of BaO and Mayenite Compound

A sputtering rate of a mayenite compound was calculated according to the Monte Carlo method with respect to a case where the Ar atoms are vertically incident on a sample (target). The TRIM code (refer to J. F. Ziegler, J. P. Biersack, U. Littmark, “The Stopping and Range of Ions in Solid”, vol. 1 of series “Stopping and Range of Ions in Matters”, Pergamon Press, New York (1984)) was used for the calculation. For comparison purpose, a sputtering rate was also calculated with respect to BaO. The sputtering rate is a number of sputtered target atoms for each incident atom or ion, and it indicates that it is more difficult to be sputtered as the number is smaller.

In the simulation, the densities of the mayenite compound, which is a target, and BaO were set to 2.67 g/cm³ and 5.72 g/cm³, respectively. Moreover, a surface bonding energy, which is an index of coupling between the atoms on the surface of a material, was set to 3.55 eV/atom with respect to the mayenite compound and 3.90 eV/atom with respect to BaO. “eV/atom” used here is a unit indicating an energy value per one atom of a material.

Moreover, a discharge gas of a fluorescent lamp, which is practically used, is a mixture gas containing Ar as a major component. Therefore, in practical example 4, a simulation was performed with respect to Ar as an incoming atom. The simulation is one that estimates an efficiency of constituent atoms of a mayenite compound or BaO escaping out of a material surface due to sputtering when a motion energy of Ar is varied in a range of 0.1 to 1.0 keV.

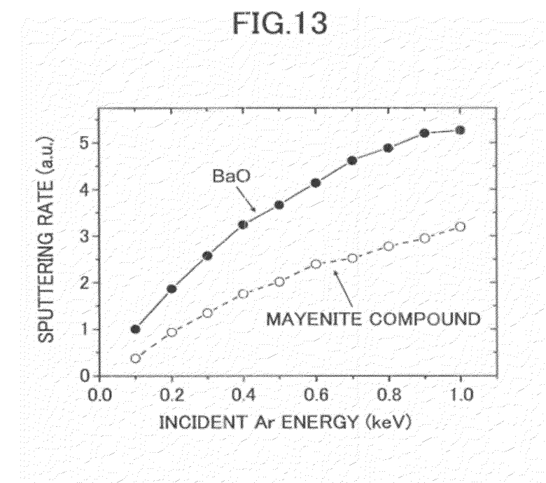

FIG. 13 illustrates calculation results in a case where the sputtering rate of BaO when Ar of 0.1 keV is incident is set to 1. It is illustrated that the sputtering rates of the mayenite compound are below that of BaO in the entire energy area in FIG. 13. It was appreciated from the above that the mayenite compound exhibits sputtering resistance higher than BaO with respect to Ar, which is a discharge gas of a fluorescent gas.

It was appreciated from the above that the electrode formed of a sintered body of a mayenite compound is stable and has good thermal electron emission property in a wide temperature range. Therefore, according to the fluorescent lamp having an electrode formed of a sintered body of a mayenite compound, wearing of an electrode at the time of discharge is suppressed, and a stable characteristic can be maintained for a long period of time.

Although the present invention has been explained in detail and by referring to specific embodiments, it is clear for a person skilled in the art that various changes and modifications can be made without departing from the spirit and scope of the present invention.

The present invention is not limited to the specifically disclosed embodiments, and variations and modifications may be made without departing from the scope of the present invention.

What is claimed is:

1. An electrode for a discharge lamp, comprising:
an electrode body comprising a sintered body comprising a conductive mayenite compound,
wherein said electrode body part is configured to emit thermal electrons.

2. The electrode as claimed in claim 1, wherein said electrode body includes a cluster structure having a neck part that is formed by particles being joined with each other, and a surface of said cluster structure has a three-dimensional concavo-convex structure comprised of the particles protruding partially.

3. The electrode as claimed in claim 1, wherein said electrode body further includes an oxide of alkaline earth metal.

4. The electrode as claimed in claim 3, wherein said oxide of alkaline earth metal includes at least one kind of oxide selected from a group consisting of barium oxide (BaO), strontium oxide (SrO) and calcium oxide (CaO).

5. A discharge lamp, comprising:
a bulb having an inner space in which mercury and a rare gas are filled;
a phosphor provided on an inner surface of the bulb; and
an electrode that causes a discharge to be generated and maintained in said internal space,
wherein said electrode is the electrode according to claim 1.

6. The discharge lamp as claimed in claim 5, wherein said electrode body includes a cluster structure having a neck part that is formed by particles being joined with each other, and a surface of said cluster structure has a three-dimensional concavo-convex structure comprised of the particles protruding partially.

7. The discharge lamp as claimed in claim 5, wherein said electrode body further includes an oxide of alkaline earth metal.

8. The discharge lamp as claimed in claim 7, wherein said oxide of alkaline earth metal includes at least one kind of oxide selected from a group consisting of barium oxide (BaO), strontium oxide (SrO) and calcium oxide (CaO).

9. A manufacturing method of an electrode for a discharge lamp comprising an electrode body that causes thermal electrons to be emitted, the manufacturing method comprising:
(1a) a step of preparing a powder containing a mayenite compound;
(1b) a step of forming a shaped material from said powder;
(1c) a step of obtaining a sintered body by firing said shaped material; and
(1d) a step of providing a conductivity to said sintered body.

10. The manufacturing method as claimed in claim 9, wherein said step (1d) of providing a conductivity includes a step of heat-treating said sintered body within a reducing atmosphere.

11. A manufacturing method of an electrode for a discharge lamp comprising an electrode body that causes thermal electrons to be emitted, the manufacturing method comprising:
(2a) a step of preparing a powder containing a mayenite compound;
(2b) a step of forming a shaped material from said powder; and
(2c) a step of obtaining a sintered body having an electrical conductivity by firing said shaped material.

12. The manufacturing method as claimed in claim 11, wherein said step (2c) of obtaining a sintered body includes a step of heat-treating said shaped material within a reducing atmosphere.
